(19) United States
(12) Patent Application Publication
(10) Pub. No.: US 2016/0274044 A1
(43) Pub. Date: Sep. 22, 2016

(54) CIRCUIT DEVICE INSPECTION SYSTEMS USING TEMPERATURE GRADIENTS

(71) Applicant: Intel Corporation, Santa Clara, CA (US)

(72) Inventors: Mayue Xie, Phoenix, AZ (US); Deepak Goyal, Phoenix, AZ (US); Thomas J. Begala, Chandler, AZ (US)

(21) Appl. No.: 14/664,726

(22) Filed: Mar. 20, 2015

(51) Int. Cl. G01N 25/00

(52) U.S. Cl. CPC G01N 25/00

(57) ABSTRACT

Circuit device inspection system using temperature gradients. In some embodiments, a system may include an infrared camera, first and second temperature sources, controller circuitry to cause the infrared camera to capture an infrared image of a region of a circuit device and to cause the first and second temperature sources to generate first and second temperature outputs to be applied to first and second locations on the circuit device, and processing circuitry to generate temperature gradient data. The temperature gradient data may be indicative of discontinuities in traces in the circuit device.

### TECHNICAL FIELD

The present disclosure relates generally to the field of circuit device testing, and more particularly, to circuit device inspection systems using temperature gradients.

### BACKGROUND

Defects in the fabrication of circuit devices (e.g., semiconductor packages) are often difficult and expensive to detect. Typically, inspection occurs at the end of the fabrication line, after significant expense and time have already been incurred, and requires resource-intensive testing techniques and hardware.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a block diagram of a circuit device inspection system, in accordance with various embodiments.

FIG. 2 illustrates a number of waveforms that may be generated within the circuit device inspection system of FIG. 1, in accordance with various embodiments.

FIG. 3 is a graphical representation of a region of a circuit device with a gap in a trace, in accordance with various embodiments.

FIG. 4 is a plot of example temperature distributions along the trace of FIG. 3 when the circuit device is under inspection by the circuit device inspection system of FIG. 1, in accordance with various embodiments.

FIG. 5 is a plot of example temperature gradients along the trace of FIG. 3 when the circuit device is under inspection by the circuit device inspection system of FIG. 1, in accordance with various embodiments.

FIG. 6 is a block diagram of controller circuitry that may be included in the circuit device inspection system of FIG. 1, in accordance with various embodiments.

FIG. 7 is a block diagram of processing circuitry that may be included in the circuit device inspection system of FIG. 1, in accordance with various embodiments.

FIGS. 8-9 are example displays of digital temperature distribution data in a region of a circuit device under inspection by the circuit device inspection system of FIG. 1, in accordance with various embodiments.

FIG. 10 is an example display of gradient data for the region of the circuit device of FIG. 8, when the circuit device is under inspection by the circuit device inspection system of FIG. 1, in accordance with various embodiments.

FIG. 11 illustrates a display of a circuit layout of the region of the circuit device superimposed on the gradient data of FIG. 10, in accordance with various embodiments.

FIG. 12 illustrates a display of a plot of example temperature distribution data and a plot of corresponding example gradient data, in accordance with various embodiments.

FIG. 13 is a flow diagram of an illustrative method for inspecting a circuit device, in accordance with various embodiments.

FIG. 14 is a block diagram of an example computing device that may provide some or all of the components of the circuit device inspection system of FIG. 1, in accordance with various embodiments.

### DETAILED DESCRIPTION

Disclosed herein are systems and methods for circuit device inspection using temperature gradients. For example, in some embodiments, a system for inspection of a circuit device may include an infrared camera, a first temperature source, a second temperature source, controller circuitry, and processing circuitry. The controller circuitry may be coupled to the infrared camera, to the first temperature source, and to the second temperature source, and may be configured to provide control signals to the infrared camera to cause the infrared camera to capture an infrared image of a region of the circuit device, to provide control signals to the first temperature source to cause the first temperature source to generate a first temperature output, and to provide control signals to the second temperature source to cause the second temperature source to generate a second temperature output. The first temperature output may be coupled to a first location on the circuit device and the second temperature output may be coupled to a second location on the circuit device. The processing circuitry may be coupled to the infrared camera and may be configured to receive infrared image data generated by the infrared camera, to generate digital temperature distribution data based on the infrared image data, and to perform a computational transformation of the digital temperature distribution data to generate gradient data. The computational transformation may include numerical differentiation and the gradient data may be indicative of a temperature gradient in the region of the circuit device.

The systems and techniques disclosed herein may serve a number of useful device inspection purposes. For example, various embodiments disclosed herein may enable space domain thermal differential mapping for circuit mapping and defect localization. The defects detectable by various embodiments disclosed herein may include defects in through-silicon vias (TSVs), solder balls (e.g., as part of a bumpless buildup layer (BBUL)), or any other conductive pathway in a circuit device.

These techniques may be applied as part of an in-line monitoring process to detect interconnect open defects (e.g., fine non-wet open defects that occur in thermal compression bonding), head and pillow defects (which occur when two solder balls fail to properly melt and join), and opens and voids within vias. Traditionally, these defects could not be identified until end-of-line testing and failure analysis, delaying the detection of failures. The feedback provided by the systems and techniques disclosed herein may be used to quickly provide in-line feedback for process optimization.

Additionally or alternatively, the systems and techniques disclosed herein may be used to localize defects during the analysis of open failures caused by cracks and traces, vias, and/or interconnects. Conventional approaches to this kind of defect localization include time domain reflectometry or electro-optical terahertz pulsed reflectometry, which provide information about failure location in terms of signal travel time. These techniques are time- and labor-intensive, requiring single speed characterization and the comparison of good units with failed units. These techniques are also limited in their ability to analyze traces or other conductive pathways that are longer than 5-6 millimeters. In contrast, various embodiments of the techniques disclosed herein may be applied to test conductive pathways in the tens or hundreds of millimeters. In another example, some embodiments may be used to aid in the non-destructive mapping of the circuit layout of a device (e.g., through current flow imaging).

In the following detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

The description uses the phrases “in an embodiment,” or “in embodiments,” which may each refer to one or more of the same or different embodiments. As used herein, the phrase “coupled” may mean that two or more elements are in direct physical or electrical contact, or that two or more elements are not in direct contact with each other, but yet still cooperate or interact with each other (e.g., via one or more intermediate elements, which may perform their own transformations or have their own effects). For example, two elements may be coupled to each other when both elements communicate with a common element (e.g., a memory device). Furthermore, the terms “comprising,” “including,” “having,” and the like, as used with respect to embodiments of the present disclosure, are synonymous. As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. As used herein, a signal may be “received” by a component if it is generated externally or internally to that component, and acknowledged and/or processed by that component.

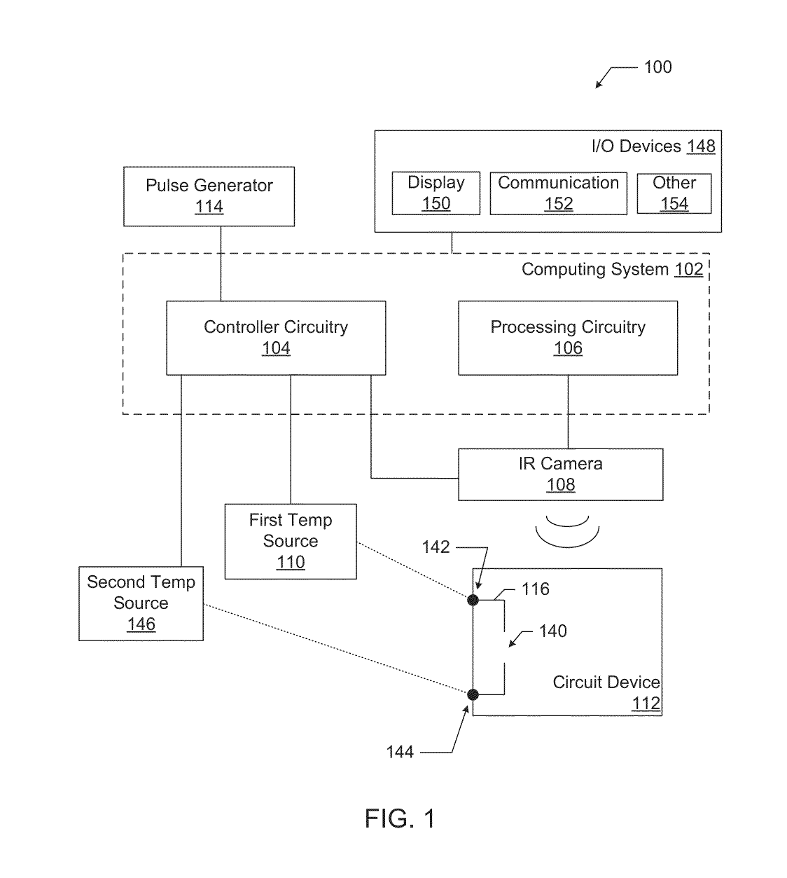

FIG. 1 is a block diagram of a circuit device inspection system 100 arranged to inspect a circuit device 112, in accordance with various embodiments. As schematically illustrated in FIG. 1, the circuit device 112 may include one or more conductive traces, such as the trace 116. As used herein, a “trace” may refer to any conductive pathway in a circuit device, including traces, vias, interconnects, and other portions of conductive material used to route electrical signals. Some of these traces may have unintended gaps that may compromise the performance of the circuit device 112. For example, the trace 116 may have a gap 140 that disrupts the conductive pathway between locations 142 and 144 along the trace 116. It will be clear that the trace 116 of the circuit device 112 illustrated in FIG. 1 is an exaggerated illustration of a conductive trace in an actual circuit device, and thus not to scale. As used herein, a “gap” may be used to refer to an interruption in a conductive pathway, and may include situations in which the conductive pathway is wholly broken (e.g., when a conductive trace fully cracks or two portions are separated by an intervening material or component) or when the conductive pathway is occluded (e.g., by a void in an otherwise solid via).

The circuit device inspection system 100 may include a computing system 102. The computing system 102 may include controller circuitry 104 and processing circuitry 106, each of which may be coupled to an infrared (IR) camera 108. In some embodiments, the controller circuitry 104 may be included in a housing separate from a housing of the processing circuitry 106. In other embodiments, the controller circuitry 104 and the processing circuitry 106 may be part of a common computing device, and may be included in a common housing and/or share one or more common processing devices. In some embodiments, the controller circuitry 104 may be included in a housing separate from a housing of the IR camera 108. In other embodiments, the controller circuitry 104 and the IR camera 108 may be part of a common camera device, and may be included in a common housing. The IR camera 108 may be any suitable commercially available IR camera, such as a camera with thermographic imaging capability, and may communicate with the computing system 102 and the controller circuitry 104 using any suitable technique (e.g., a General Purpose Interface Bus (GPIB) or Universal Serial Bus (USB)). In some embodiments, the IR camera 108 may include an array of imaging sensors (e.g., a planar focal array).

In some embodiments, the computing system 102 may be configured to receive digital temperature distribution data indicative of a temperature distribution in a region of a circuit device (e.g., the circuit device 112). The computing system 102 may be configured to perform a computational transformation of the digital temperature distribution data to generate gradient data indicative of a temperature gradient in the region of the circuit device. The computing system 102 may be configured to compare the gradient data to a threshold to determine that at least some of the gradient data exceeds the threshold, and to output an indication of the comparison. For example, the computing system 102 may be configured to output (e.g., to one or more of the I/O devices 148) an indication of a location in the region of the circuit device that corresponds to the at least some of the gradient data that exceeds the threshold. As used herein, the phrase “exceeds a threshold” may be used to generally refer to the crossing of a threshold in a suitable direction, and may cover the situation in which a value is larger than an upper threshold or is lower than a lower threshold. In another example, the computing system 102 may be configured to cause the display of the gradient data and a visual indication of a correspondence between the gradient data and the region of the circuit device 112.

The controller circuitry 104 may be configured to cause the IR camera 108 to capture one or more IR images of a region of the circuit device 112. The controller circuitry 104 may be coupled to the IR camera 108 via a wired or wireless connection capable of transmitting control signals from the controller circuitry 104 to the IR camera 108, in response to which the IR camera 108 may capture the IR images.

In some embodiments, the imaged region of the circuit device 112 may not be located at an external surface of the circuit device 112, but may be “below the surface” (e.g., between two opposing surfaces of the circuit device 112). For example, in some embodiments, the imaged region of the circuit device 112 may be parallel to and located between two opposing surfaces of the circuit device 112. When the imaged region is located at a depth below the surface, the depth may be determined based on data extracted from a collection of multiple infrared images of the circuit device 112. For example, the delay between the application of a temperature output (e.g., a heat or cool source) and the appearance of a temperature difference at a surface of the circuit device 112 in an IR image (i.e., the time-of-flight of the heat) may be used to approximate the depth at which a temperature change occurs, given an approximate propagation velocity of heat within the circuit device 112 (a property that may be estimated based on the known structure and materials of the circuit device 112).

The processing circuitry 106 may be configured to receive IR image data from the IR camera 108. When the IR camera 108 captures images of the region of the circuit device 112, the IR image data received by the processing circuitry 106 will be IR image data of the region of the circuit device 112. The processing circuitry 106 may be coupled to the IR camera 108 via a wired or wireless connection capable of transmitting IR image data from the IR camera 108 to the processing circuitry 106. As discussed in detail below, the processing circuitry 106 may be configured to process the IR image data to generate gradient data indicative of a temperature gradient in the region of the circuit device 112, and to use the gradient data to indicate the presence and/or location of discontinuities in one or more conductive traces in the region of the circuit device 112.

The controller circuitry 104 may also be coupled to a first temperature source 110 and a second temperature source 146. The first temperature source 110 and the second temperature source 146 may be electrical devices configured to generate a desired temperature output and to substantially hold that temperature output, as known in the art. The temperatures output by each of the first temperature source 110 and the second temperature source 146 may be controlled by control signals from the controller circuitry 104 or may be manually controlled by knobs or push buttons on housings of the first temperature source 110 and the second temperature source 146, for example. In some embodiments, the controller circuitry 104 may be configured to cause the first temperature source 110 to generate a first temperature output in response to control signals provided to the first temperature source 110 by the controller circuitry 104. The controller circuitry 104 may also be configured to cause the second temperature source 146 to generate a second temperature output in response to control signals provided to the second temperature source 146 by the controller circuitry 104. The first temperature output generated by the first temperature source 110 and the second temperature output generated by the second temperature source 146 may be different temperatures. Without loss of generality, the first temperature source 110 will be described herein as producing a first temperature output that is a higher temperature than the second temperature output produced by the second temperature source 146. In some embodiments, the first temperature source 110 may be a heat generator and the second temperature source 146 may be a cooling system. The first temperature source 110 and the second temperature source 146 may take any suitable forms, such as electrical heating/cooling elements (e.g., Peltier heaters/coolers) or gas heating/cooling elements. The temperature difference between the first and second temperature outputs may be a tunable parameter, and may be adjusted to achieve a desired heat flux and gradient.

The first and second temperature outputs may be applied to desired locations on the circuit device 112 in any suitable manner. For example, the temperature sources may include probe tips that output the desired temperature, and the probe tip may be applied to the desired location. In another example, a wire may be soldered to the desired location on the circuit device 112, and that wire may be heated or cooled to the desired temperature. In another example, the circuit device 112 may include a dedicated socket with pins that may couple to the desired locations; in such embodiments, the temperature outputs may be applied to the pins of the socket.

In some embodiments, the controller circuitry 104 may be coupled to a pulse generator 114. The pulse generator 114 may generate a regular train of electrical pulses (e.g., current or voltage pulses) having a predetermined duration and frequency. In some embodiments, the duration and frequency of the pulse train generated by the pulse generator 114 may be adjustable, as known in the art. When the controller circuitry 104 is coupled to the pulse generator 114, the controller circuitry 104 may use the pulse train generated by the pulse generator 114 to control the timing of control signals transmitted by the controller circuitry 104 to the IR camera 108, the first temperature source 110, and/or the second temperature source 146. For example, the IR camera 108 may capture IR images on the rising or falling edges of the pulse train generated by the pulse generator 114. In some embodiments, the first temperature source 110 and the second temperature source 146 may be configured to turn “ON” for a predetermined number of pulses and then turn off for a predetermined number of pulses. Use of a common timing waveform may enable accurate synchronization between heating/cooling and image capture. In some embodiments, the controller circuitry 104 may include a pulse generator 114 or other appropriate timing circuitry. In other embodiments, the controller circuitry 104 and the pulse generator 114 may be separate devices, included in different housings.

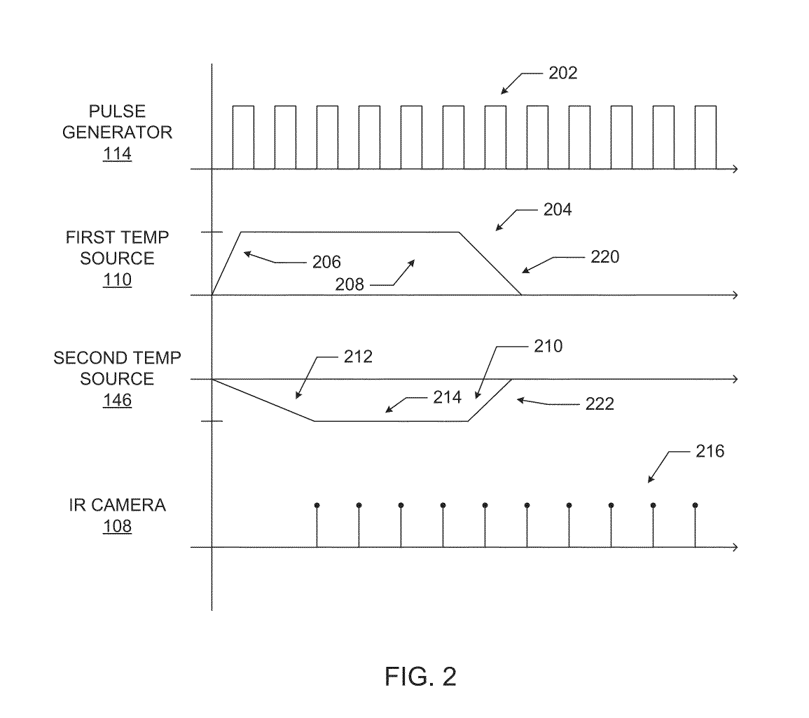

To inspect the circuit device 112, the output of the first temperature source 110 may be thermally coupled to the location 142 on the trace 116 (e.g., at one end of the trace 116) and the output of the second temperature source 146 may be thermally coupled to the location 144 on the trace 116 (e.g., at the other end of the trace 116). The first temperature source 110 may begin to output to the desired first temperature, causing the location 142 to heat or cool to the first temperature. The second temperature source 146 may begin to output to the desired second temperature, causing the location 144 to heat or cool to the second temperature. FIG. 2 illustrates a number of waveforms that may be generated within the circuit device inspection system 100 during the inspection of the circuit device 112, in accordance with various embodiments. In particular, FIG. 2 illustrates an electrical pulse train 202 generated by the pulse generator 114, as well as the first temperature output 204 of the first temperature source 110 and the second temperature output 210 of the second temperature source 146.

The first temperature output 204 of the first temperature source 110 may have an initial ramp up 206 from ambient temperature before reaching its steady-state output 208. The second temperature output 210 of the second temperature source 146 may have an initial ramp down 212 before reaching its steady-state output 214. These initial phases 206 and 212 are simply illustrative; in some embodiments, both the first temperature output 204 and the second temperature output 210 may have an initial ramp up, or an initial ramp down. In some embodiments, as illustrated in FIG. 2, the first temperature output 204 and the second temperature output 210 may be periodic, or have at least one “ON” period and at least one “OFF” period. In FIG. 2, the “ON” period of the first temperature output 204 is bounded by the ramp up 206 and the ramp down 220, while the “ON” period of the second temperature output 210 is bounded by the ramp down 212 and the ramp up 222. “OFF” periods follow the ramp down 220 and the ramp up 222. IR images of the circuit device 112 may be captured during both the “ON” and “OFF” periods (e.g., as discussed below with reference to image processing techniques). In some embodiments, the first temperature output 204 and the second temperature output 210 may be approximately symmetric with respect to each other (e.g., symmetric around a starting temperature), but this need not be the case, and either waveform may take any suitable shape.

In some embodiments, only a single temperature source may be used, instead of two temperature sources. In such an embodiment, the temperature output of the single temperature source may be coupled to the circuit device 112 at a desired location, and the circuit device 112 may be heated and/or cooled in accordance with the temperature output. In such an embodiment, the ambient temperature may provide an approximate “second temperature source” (although the ambient temperature may not be maintained as the circuit device 112 heats or cools).

The IR camera 108 may capture IR images of a region of the circuit device 112 including the trace 116. FIG. 2 includes an image capture waveform 216, indicating the times at which the IR camera 108 may capture images of the circuit device 112. As shown, in some embodiments, the capture of images by the IR camera 108 may be triggered by the electrical pulse train 202 generated by the pulse generator 114 (e.g., on the rising or falling edge of the pulses in the pulse train 202). In some embodiments, the IR camera 108 may capture IR images of the trace 116 as the locations 142 and 144 are reaching their final temperatures, as well as after the locations 142 and 144 have reached their final temperatures. In some embodiments, the IR camera 108 may only capture IR images of the trace 116 after the locations 142 and 144 have reached the final temperatures. Some or all of the IR images captured by the IR camera 108 at the times indicated by the image capture waveform 216 may be transmitted to the processing circuitry 106 for processing.

The processing circuitry 106 may be configured to receive the IR image data from the IR camera 108, and to generate digital temperature distribution data based on the IR image data. The digital temperature distribution data may be indicative of a temperature distribution in the imaged region of the circuit device 112. In particular, the digital temperature distribution data may indicate the spatial distribution of temperature in the region of the circuit device 112. In embodiments in which multiple IR images of the circuit device 112 are captured at different points in time, the digital temperature distribution data may have a temporal component, indicating changes in the spatial distribution of temperature of the circuit device 112 over time. Techniques for generating temperature distribution data from IR images are known, and thus the basic techniques are not discussed herein. Note that in some embodiments, the IR camera 108 may include processing circuitry to generate the digital temperature distribution data from the IR image data, and then may transmit the digital temperature distribution data to the processing circuitry 106 for further processing. Commercially available IR cameras may achieve resolutions of approximately 1 milliKelvin or less.

The processing circuitry 106 may be configured to perform a computational transformation of the digital temperature distribution data to generate gradient data. The gradient data may be indicative of a temperature gradient in the imaged region of the circuit device 112. As used herein, the term “temperature gradient” may refer to an indicator of spatial changes in temperature over an imaged region of a circuit device (e.g., the circuit device 112). In some embodiments, the computational transformation may include numerical differentiation, but other differentiation-like techniques may be used to generate an appropriate gradient. The computational transformation performed by the processing circuitry 106 may include any other suitable data processing operations. For example, in some embodiments, the computational transformation may include applying a noise reduction filter (e.g., by combining the data from multiple thermal images to reduce noise and increase the signal-to-noise ratio). One example of a noise reduction filter that may be applied is a spatial moving average to achieve spatial low-pass filtering.

The processing circuitry 106 may generate gradient data for the entire imaged region of the circuit device 112, or may generate gradient data for a proper subset of the imaged region of the circuit device 112. For example, if the trace 116 is of interest, the processing circuitry 106 may generate gradient data for the portion of the imaged region corresponding to the trace 116 (and may include a neighborhood around the trace 116). If there are multiple traces of interest, the processing circuitry 106 may generate gradient data for each of these traces in turn. In some embodiments, the processing circuitry 106 may include a memory that stores a circuit schematic or other representation of the location of traces or other features of interest in the circuit device 112, and the processing circuitry 106 may register this schematic or other representation with the digital temperature distribution data in order to identify what portions of the digital temperature distribution data correspond to what traces or other features of interest.

It has been observed that heat travels much faster through conductive materials (e.g., copper) than in the dielectric materials, underfill, air, or epoxy that are typically present in a gap. For example, copper has a heat conductivity of 400 watts per meter degree Kelvin, while dielectric materials typically have a heat conductivity in the range of 0.4 watts per meter degree Kelvin. This difference in heat conduction (approximately 3 orders of magnitude) between these two types of materials may result in a sharp temperature transition near a gap if one end of the trace is maintained at a higher temperature than the other end of the trace. Moreover, the contact between the conductive material and its surrounding dielectric material at a gap may be very lossy, which will increase the magnitude of the temperature transition. Thus, in various embodiments, the circuit device inspection system 100 may localize a gap in a trace by creating a temperature difference between two ends of a trace (e.g., by “heating up” one end of the trace). Heat may travel from the warmer end of the trace toward the cooler end of the trace, raising the temperature of the trace along the way, until the heat reaches the gap. Because of the much higher heat resistance at the gap, the heat conduction may significantly slow down and a large temperature drop may occur. By using an infrared camera with the right wavelength to image the trace, this abrupt temperature change may be detected. A thermal differentiation algorithm may then compute the temperature gradient along the trace, revealing the location of the process defect or failure.

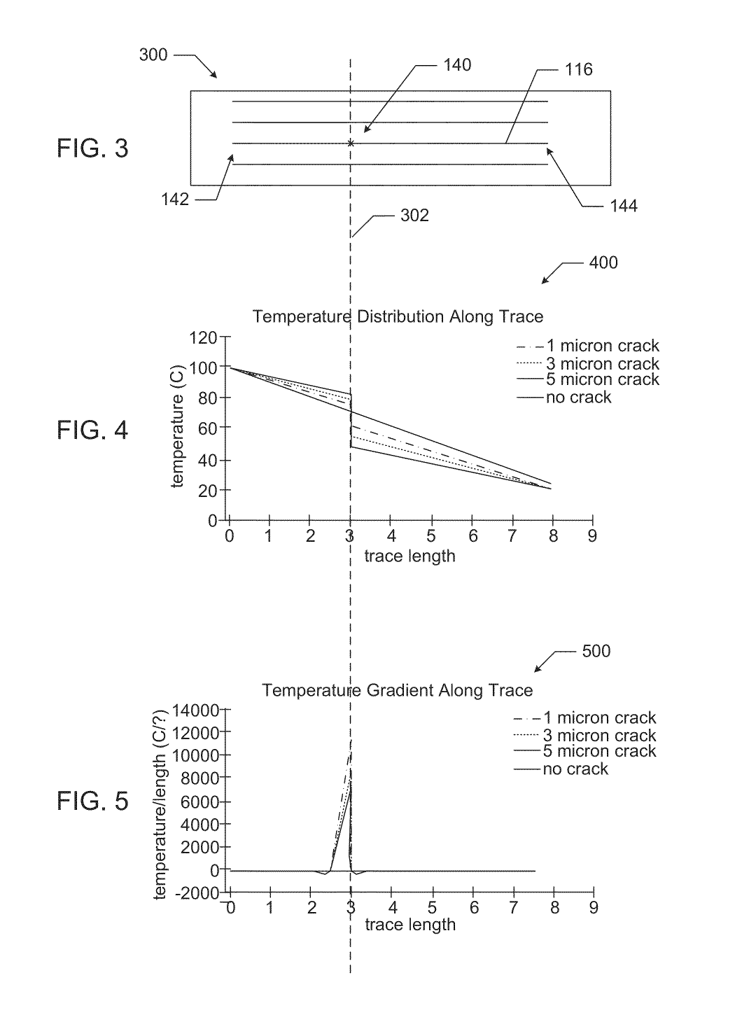

An example of the ability of the systems and techniques disclosed herein to identify discontinuities of various sizes and conductive traces within circuit devices is discussed below with reference to FIGS. 3-5. FIG. 3 is a graphical representation 300 of a region of the circuit device 112. The region of the circuit device 112 includes a number of traces, and depicts the location of the gap 140 in the trace 116, in accordance with various embodiments. The reference line 302 extends through FIGS. 3-5 to indicate the location of the gap 140. During inspection of the circuit device 112, a first temperature output from the first temperature source 110 may be provided to the first location 142 on the trace 116, and a second temperature output from the second temperature source 146 may be provided to a second location 144 on the trace 116. In the example illustrated in FIG. 3, the trace has a length of 8 millimeters, the first location 142 is at one end of the trace 116, the second location 144 is at the opposite end of the trace 116, and the gap 140 is located 3 millimeters from the first location 142. The gap 140 may take the form of a crack having various widths, as discussed below with reference to FIGS. 4-5.

FIG. 4 is a plot 400 of example temperature distributions along the trace 116 of FIG. 3 when the circuit device 112 is under inspection by the circuit device inspection system 100, in accordance with various embodiments. In particular, FIG. 4 illustrates the temperature at various points along the length of the trace 116 for different widths of the crack providing the gap 140. These crack widths are 1 micron, 3 microns, and 5 microns. A reference temperature distribution when no crack is present is also provided. In FIG. 4, the first temperature output (provided to the first location 142) is 100 degrees Celsius and the second temperature output (provided to the second location 144) is 20 degrees Celsius.

As shown in the plot 400, when no crack is present in the trace 116, the temperature distribution along the trace 116 is substantially linear between the first temperature output and a second temperature output. When a crack is present, the temperature change on either side of the crack is linear with distance, but there is a discontinuity at the crack. As the size of the crack increases, the size of the discontinuity increases.

FIG. 5 is a plot 500 of example temperature gradients along the trace 116 of FIG. 3 when the circuit device 112 is under inspection by the circuit device inspection system 100, in accordance with various embodiments. In particular, the data of the plot 500 may be generated by the processing circuitry 106 by performing, among other transformations, a numerical differentiation of the temperature distributions of FIG. 4. As shown in the plot 500, when no crack is present in the trace 116, the temperature gradient along the trace is substantially zero. When a crack is present, a peak in the temperature gradient occurs at the location of the crack. As the size of the crack increases, the magnitude of the temperature gradient at the crack increases.

Upon generating gradient data, the processing circuitry 106 may compare the gradient data to a threshold. In some embodiments, the processing circuitry 106 may compare the gradient data to a threshold by generating a gradient heat map of the gradient data. As used herein, a “gradient heat map” may refer to a visualization of the gradient data in which common colors or patterns are used to indicate areas of the imaged region having similar temperature gradient values. To determine what color or pattern to use for a particular area of the imaged region, the processing circuitry 106 may compare the gradient data to the thresholds for the different colors or patterns, and select the appropriate color or pattern.

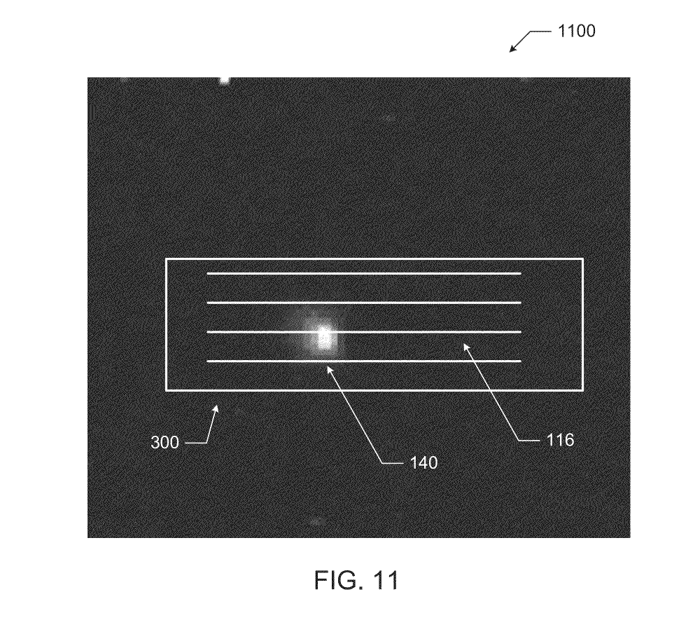

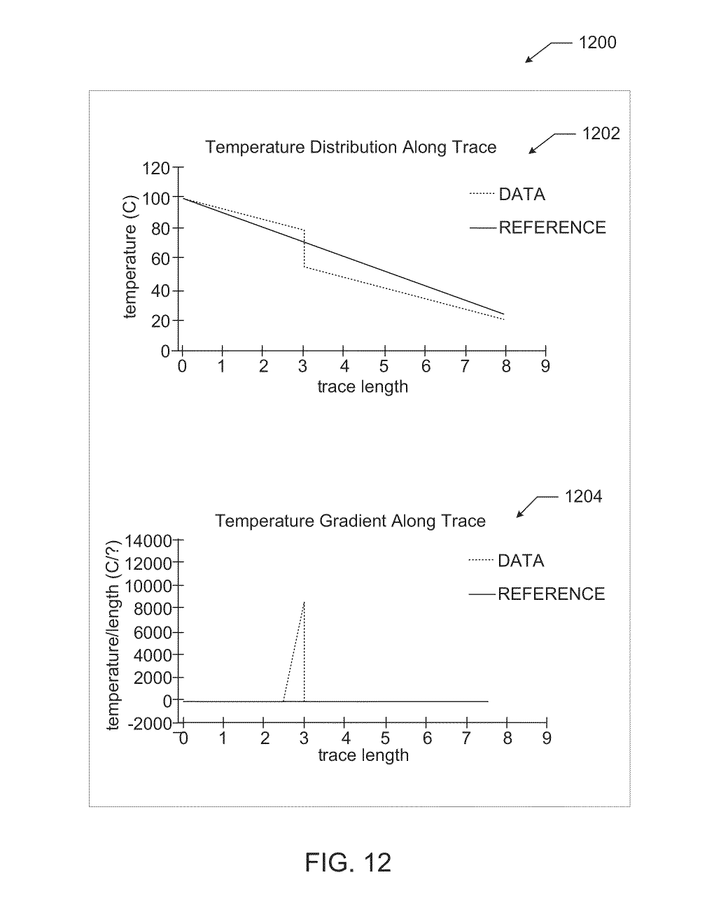

The processing circuitry 106 may cause the output of various thermal data to a display, storage device, or other computing device. For example, the processing circuitry 106 may cause the display of the gradient data and a visual indication of a correspondence between the gradient data in the imaged region of the circuit device 112. In some embodiments, the processing circuitry 106 may cause the display of an indicator of the gradient data superimposed on a graphical representation of the region of the circuit device 112. An example of this is given in FIG. 11. The graphical representation of the region of the circuit device 112 may be a circuit layout diagram of the region of the circuit device 112 and/or an x-ray or other image of the region of the circuit device 112, for example. In some embodiments, the processing circuitry 106 may be configured to cause the display of a graph comparing the gradient data to corresponding locations along a trace (e.g., the trace 116) in the region of the circuit device 112. An example of this is given in FIG. 12.

In embodiments in which the processing circuitry 106 compares the gradient data to a threshold, the processing circuitry 106 may be configured to output an indication of a location in the region of the circuit device 112 that corresponds to gradient data that exceeds the threshold. For example, the processing circuitry 106 may be configured to cause the display of a gradient heat map. Examples of this are given in FIGS. 9-11. In another example, the processing circuitry 106 may be configured to cause the display of a visual indicator of a location in the region of the circuit device 112 that has a gradient value with a large enough magnitude to indicate a gap in a conductive trace at that location. Examples of this are given in FIGS. 11 and 12.

The circuit device inspection system 100 may include input/output (I/O) devices 148. The I/O devices 148 may include a display 150, a communication device 152, and/or other I/O devices 154. Although the I/O devices 148 (and other components described herein) may be referred to in the plural, any number of I/O devices may be included in the I/O devices 148 (and similarly, any component may include multiple such components).

The display 150 may include one or more heads-up displays (i.e., displays including a projector arranged in an optical collimator configuration and a combiner to provide data without requiring a user to look away from his or her typical viewpoint), computer monitors, projectors, touchscreen displays, liquid crystal displays (LCDs), light-emitting diode displays, or flat panel displays, for example. In some embodiments, the display 150 may be coupled to the processing circuitry 106, and configured to generate displays based on control signals provided to the display 150 by the processing circuitry 106, as known in the art.

The communication device 152 may include one or more devices that enable wireless and/or wired communication between various devices instantiating the circuit device inspection system 100 and with devices external to the circuit device inspection system 100. In particular, the communication device 152 may include network interface cards, modems, WiFi devices, Bluetooth devices, or Near Field Communications (NFC) devices, and so forth, and may enable the transmission of data from the processing circuitry 106 to other devices for display, storage, process control, or further communication.

The other I/O devices 154 may include any other suitable I/O devices, such as a keyboard, a cursor control device such as a mouse, a stylus, a touchpad, a bar code reader, a Quick Response (QR) code reader, a Radio Frequency Identification (RFID) reader, a short-range wireless receiver (e.g., a Bluetooth receiver), an audio capture device (which may include one or more microphones arranged in various configurations), an audio output device (e.g., one or more speakers or other audio transducers that may be, for example, mounted in one or more earphones or earbuds), printers, projectors, additional storage devices, or any other suitable I/O device. Input devices included in the other I/O devices 154 may enable an operator of the circuit device inspection system 100 to input any suitable parameters to the circuit device inspection system 100 to control the operation of the circuit device inspection system 100. For example, an input keypad or touchscreen may enable an operator to adjust the first temperature output by the first temperature source 110, the second temperature output by the second temperature source 146, the frequency or pulse width of the pulse generator 114 (when present), the frequency of electromagnetic radiation captured by the IR camera 108, the image processing operations applied to the IR images captured by the IR camera 108, and/or any other suitable parameters.

Communication within the circuit device inspection system 100 may be enabled by communication pathways that include wired communication pathways and/or wireless communication pathways, over direct couplings, and/or over personal, local, and/or wide area networks. Each of the components of the circuit device inspection system 100 (such as the controller circuitry 104 and the processing circuitry 106) may include suitable hardware for supporting such communications, such as network interface cards, modems, WiFi devices, Bluetooth devices, and so forth. Each of the components included in the circuit device inspection system 100 may include a processing device and a storage device (not shown), as suitable. The processing device may include one or more processing devices, such as one or more processing cores, ASICs, electronic circuits, processors (shared, dedicated, or group), combinational logic circuits, and/or other suitable components that may be configured to process electronic data. The storage device may include any suitable memory or mass storage devices (such as solid-state drive, diskette, hard drive, compact disc read-only memory (CD-ROM), and so forth). Each of the computing devices included in the circuit device inspection system 100 may include one or more buses (and bus bridges, if suitable) to communicatively couple the processing device, the storage device, and any other devices included in the respective computing devices.

The storage device may include a set of computational logic, which may include one or more copies of computer readable media (e.g., non-transitory computer readable media) having instructions stored therein that, when executed by the processing device of the computing device, may cause the computing device to implement any of the techniques and methods disclosed herein, or any portion thereof.

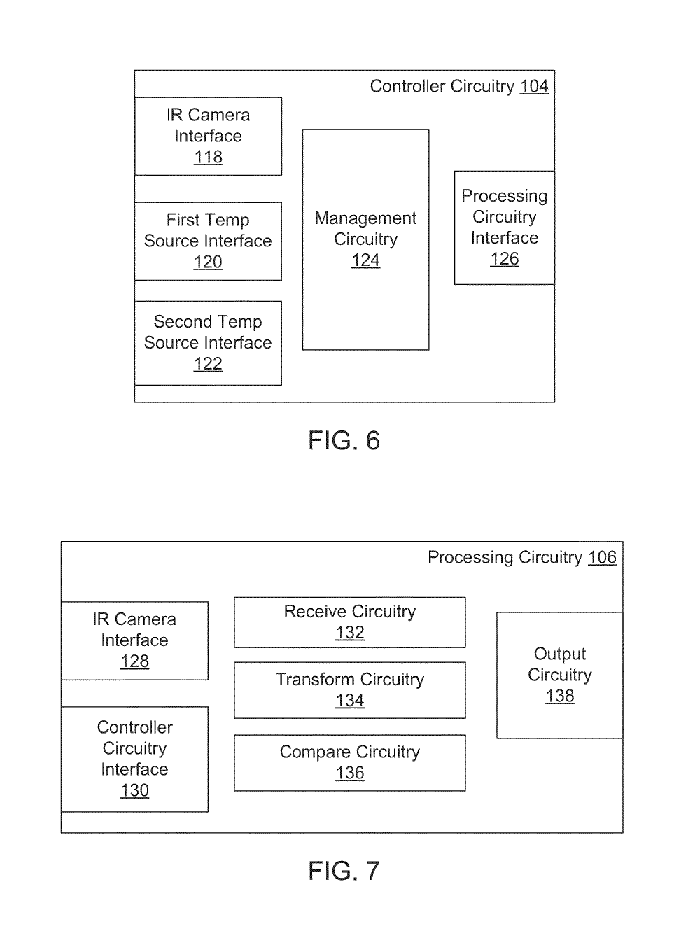

FIG. 6 is a block diagram of the controller circuitry 104 that may be included in the circuit device inspection system 100, in accordance with various embodiments. Although the components of the controller circuitry 104 are illustrated separately, the components may be combined or divided as suitable, and each may use one or more of the results generated by others in performing its own processing, as discussed below. Data may be communicated between the components of the controller circuitry 104 over a physical bus, a long-distance wired communication pathway, a short- or long-distance wireless communication pathway, or any combination of communication pathways. The controller circuitry 104 may include a storage device (not shown). In some embodiments, the storage device may include one or more databases or other data storage structures, which may include memory structures for storing any of the data described herein for circuit device inspection operations. The storage device may include any volatile or nonvolatile memory device, such as one or more hard drives, solid state logic, or portable storage media, for example.

The controller circuitry 104 may include an IR camera interface 118. The IR camera interface 118 may be configured to couple to the IR camera 108 and to provide control signals to the IR camera 108 to cause the IR camera 108 to capture IR images. The IR camera interface 118 may implement any suitable wired or wireless communication protocol to communicate control signals from the controller circuitry 104 to the IR camera 108.

The controller circuitry 104 may include a first temperature source interface 120 and a second temperature source interface 122. The first temperature source interface 120 and the second temperature source interface 122 may be configured to cause the first temperature source 110 and the second temperature source 146, respectively, to generate a first temperature output and a second temperature output, respectively, in response to control signals provided by the controller circuitry 104. The first temperature source interface 120 and the second temperature source interface 122 may implement any suitable wired or wireless communication protocols to communicate control signals from the controller circuitry 104 to the first temperature source 110 and the second temperature source 146, respectively.

In some embodiments, the controller circuitry 104 may include a processing circuitry interface 126. The processing circuitry interface 126 may be configured to couple to the processing circuitry 106 to communicate data from the controller circuitry 104 to and/or from the processing circuitry 106. For example, in embodiments in which the processing circuitry 106 receives user inputs indicative of desired operational parameters of the circuit device inspection system 100, suitable ones of those parameters may be communicated to the controller circuitry 104 for use in controlling the operation of, e.g., the IR camera 108, the first temperature source 110, and/or the second temperature source 146. In another example, in embodiments in which the controller circuitry 104 receives user inputs indicative of desired operational parameters of the circuit device inspection system 100, suitable ones of those parameters may be communicated to the processing circuitry 106. In another example, the controller circuitry 104 may communicate error conditions of the IR camera 108, the first temperature source 110, and/or the second temperature source 146 to the processing circuitry 106 (e.g., for display to an operator via the display 150). The processing circuitry interface 126 may implement any suitable wired or wireless communication protocol to communicate signals between the controller circuitry 104 and the processing circuitry 106.

The controller circuitry 104 may include management circuitry 124. The management circuitry 124 may be coupled to the IR camera interface 118, the first temperature source interface 120, the second temperature source interface 122, and/or the processing circuitry interface 126, and may include circuitry configured to translate inputs from any one of these components (or from other inputs) into output for any one of these components (or other outputs). For example, in embodiments in which the processing circuitry 106 receives user inputs indicative of desired operational parameters of the circuit device inspection system 100, suitable ones of those parameters may be communicated to the controller circuitry 104 and processed by the management circuitry 124 to generate signals for use in controlling the operation of, e.g., the IR camera 108, the first temperature source 110, and/or the second temperature source 146. In another example, in embodiments in which the controller circuitry 104 receives user inputs indicative of desired operational parameters of the circuit device inspection system 100, suitable ones of those parameters may be processed by the management circuitry and communicated to the processing circuitry 106. In another example, the management circuitry 124 may be configured with limits on the suitable operational parameters of various components of the circuit device inspection system 100 (e.g., a maximum and minimum temperature that may be output by the first temperature source 110 and/or the second temperature source 146), and may control the operation of these components to stay within these limits or provide information about these limits to an operator.

FIG. 7 is a block diagram of the processing circuitry 106 that may be included in the circuit device inspection system 100, in accordance with various embodiments. Although the components of the processing circuitry 106 are illustrated separately, the components may be combined or divided as suitable, and each may use one or more of the results generated by others in performing its own processing, as discussed below. Data may be communicated between the components of the processing circuitry 106 over a physical bus, a long-distance wired communication pathway, a short- or long-distance wireless communication pathway, or any combination of communication pathways. The processing circuitry 106 may include a storage device (not shown). In some embodiments, the storage device may include one or more databases or other data storage structures, which may include memory structures for storing any of the data described herein for circuit device inspection operations. The storage device may include any volatile or nonvolatile memory device, such as one or more hard drives, solid state logic, or portable storage media, for example.

The processing circuitry 106 may include an IR camera interface 128. The IR camera interface 128 may be configured to couple to the IR camera 108 and to receive IR image data from the IR camera 108. In some embodiments, the data provided to the processing circuitry 106 from the IR camera 108 via the IR camera interface 128 may be raw IR image data, while in other embodiments, the data may have been preliminarily processed (e.g., to convert the raw IR image data into temperature distribution data). The IR image data provided by the IR camera 108 may be analog or digital. In embodiments in which the IR image data provided by the IR camera 108 is analog, the IR camera interface 128 may include an analog-to-digital converter (ADC) to convert the analog data into digital data. The IR camera interface 128 may implement any suitable wired or wireless communication protocol to communicate data from the IR camera 108 to the processing circuitry 106.

In some embodiments, the processing circuitry 106 may include a controller circuitry interface 130. The controller circuitry interface 130 may be configured to couple to the controller circuitry 104 to communicate data from the processing circuitry 106 to and/or from the controller circuitry 104. For example, as noted above, in embodiments in which the processing circuitry 106 receives user inputs indicative of desired operational parameters of the circuit device inspection system 100, suitable ones of those parameters may be communicated to the controller circuitry 104 for use in controlling the operation of, e.g., the IR camera 108, the first temperature source 110, and/or the second temperature source 146. In another example, in embodiments in which the controller circuitry 104 receives user inputs indicative of desired operational parameters of the circuit device inspection system 100, suitable ones of those parameters may be communicated to the processing circuitry 106 via the controller circuitry interface 130. In another example, the controller circuitry 104 may communicate error conditions of the IR camera 108, the first temperature source 110, and/or the second temperature source 146 to the processing circuitry 106 (e.g., for display to an operator via the display 150) via the controller circuitry interface 130. The controller circuitry interface 130 may implement any suitable wired or wireless communication protocol to communicate signals between the controller circuitry 104 and the processing circuitry 106.

The processing circuitry 106 may include receive circuitry 132. The receive circuitry 132 may be coupled to the IR camera interface 128, and may be configured to receive digital temperature distribution data. As discussed above, the digital temperature distribution data may be indicative of a temperature distribution in a region of the circuit device 112 imaged by the IR camera 108. In some embodiments, the receive circuitry 132 may receive the digital temperature distribution data by receiving IR image data from the IR camera interface 128 and converting the IR image data into digital temperature distribution data. In other embodiments, the IR camera 108 may convert the IR image data into digital temperature distribution data, and the receive circuitry 132 may receive that digital temperature distribution from the IR camera 108.

In some embodiments, multiple IR images may be combined to generate the digital temperature distribution data. For example, in some embodiments, an IR image captured when one or more of the temperature sources are “OFF” may be used as a baseline and may be subtracted from an IR image captured when the temperature sources are “ON” in order to isolate the effects of the applied temperature outputs. In some embodiments, one or more IR images may be captured when one or more of the temperature sources are “ON” and one or more IR images may be captured when one or more of the temperature sources are “OFF”; all of these captured images may then be integrated to amplify the heat signature signal from the random noise in the images.

The processing circuitry 106 may include transform circuitry 134. The transform circuitry 134 may be coupled to the receive circuitry 132, and may be configured to perform a computational transformation of the digital temperature distribution data to generate gradient data. As discussed above, the gradient data may be indicative of a temperature gradient in an imaged region of the circuit device 112. In some embodiments, the computational transformation may include numerical differentiation, but other differentiation-like techniques may be used to generate an appropriate gradient. The computational transformation performed by the transform circuitry 134 may include any other suitable data processing operations. For example, in some embodiments, the computational transformation may include applying a noise reduction filter. Other operations may include performing a Fast Fourier Transform and removing outliers (e.g., saturated or dead pixels in an IR image).

The processing circuitry 106 may include compare circuitry 136. The compare circuitry 136 may be coupled to the transform circuitry 134, and may be configured to compare the gradient data to one or more thresholds. As noted above, in some embodiments, the processing circuitry 106 may compare the gradient data to a threshold by generating a gradient heat map of the gradient data. To determine what color or pattern to use for a particular area of the imaged region, the compare circuitry 136 may compare the gradient data to the thresholds for the different colors or patterns, and select the appropriate color or pattern. In some embodiments, a storage device coupled to the compare circuitry 136 may store a predetermined gradient threshold value, and the compare circuitry 136 may be configured to compare the gradient data to this predetermined gradient threshold value; if some of the gradient data exceeds this threshold, the processing circuitry 106 may cause the display of an indicator to an operator that there is a likely gap in an electrically conductive portion of the circuit device 112. Examples of such embodiments are discussed in further detail herein.

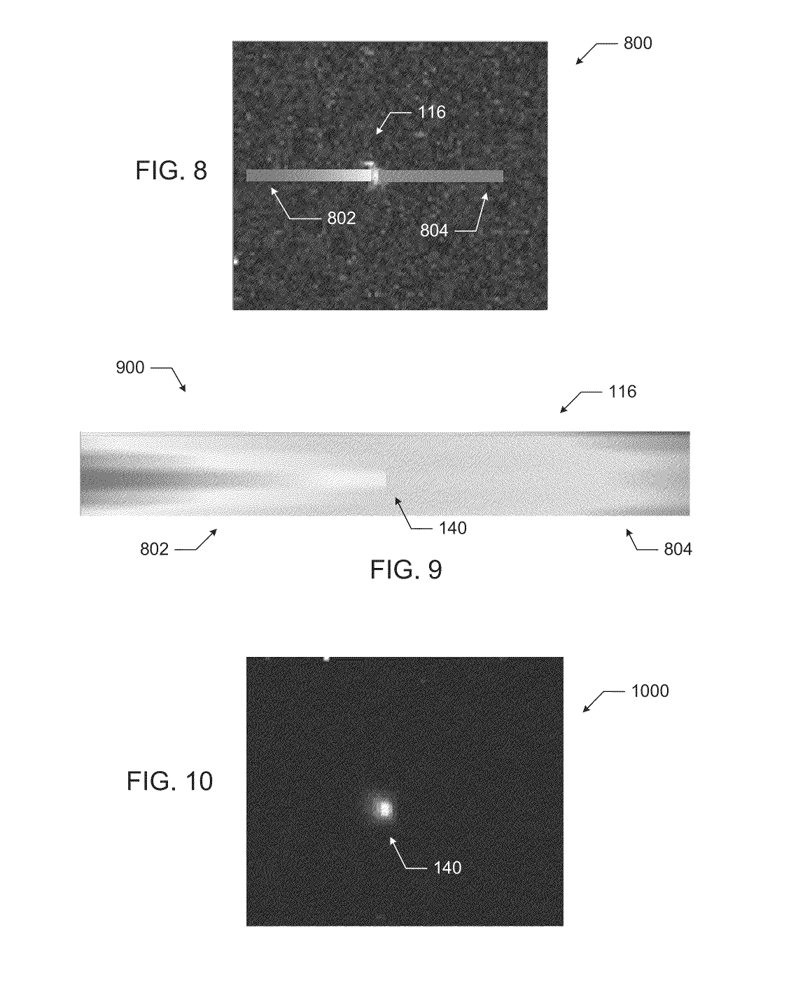

The processing circuitry 106 may include output circuitry 138. The output circuitry 138 may be coupled to the compare circuitry 136, and may be configured to cause the output of at least some of the temperature-related data (e.g., the digital temperature distribution data and/or the gradient data). For example, FIGS. 8-9 are example displays of digital temperature distribution data in a region of the circuit device 112, in accordance with various embodiments. The output circuitry 138 may cause these displays to be output to the display 150, for example. In particular, FIG. 8 depicts a display 800 of digital temperature distribution data representative of the trace 116 when the first temperature output from the first temperature source 110 is applied to the trace 116 to provide the high temperature side 802 and the second temperature output from the second temperature source 146 is applied to the trace 116 to provide the low temperature side 804. The display 800 uses color or pattern to indicate temperature, and is thus an example of a heat map (indicating a relationship between the temperature and various thresholds corresponding to the different colors or patterns). The contrast of temperature between the trace 116 and the surrounding region of the circuit device 112 is visually clear. FIG. 9 depicts a display 900 of digital temperature distribution data representative of the trace 116 under the same inspection conditions as FIG. 8, but the display 900 is zoomed and cropped to show the detail of the temperature distribution in just the region of the trace 116. The display 900 is also a heat map, and the gap 140 is indicated by the abrupt change in shading.

FIG. 10 is an example display 1000 of gradient data for the region of the circuit device of FIG. 8, and uses color or patterns to indicate the value of the gradient at various locations. The output circuitry 138 may cause this display to be output to the display 150, for example. The display 1000 uses color or patterns to indicate the magnitude of the temperature gradient, and is thus an example of a heat map (indicating a relationship between the temperature gradient and various thresholds corresponding to the different colors or patterns). The gap 140 stands out strongly in the display 1000 as a location with a particularly high temperature gradient.

In some embodiments, the output circuitry 138 may cause the display of a visual indication of a correspondence between the gradient data and the region of the circuit device. For example, the output circuitry may cause the display of an indicator of the gradient data superimposed on a graphical representation of the imaged region of the circuit device 112. FIG. 11 illustrates a display 1100 of the graphical representation 300 (FIG. 3) of the region of the circuit device 112 superimposed on the gradient data of FIG. 10, in accordance with various embodiments. In this display, the location of the gap 140 along the trace 116 is visually clear to an operator of the circuit device inspection system 100. In some embodiments, the processing circuitry 106 may also cause the provision of a graphical user interface (GUI) that allows the operator to zoom in on or pan around to various areas of interest in the display 1100.

In another example, the output circuitry 138 may cause the display of a graph comparing the gradient data to corresponding locations along a trace in the imaged region of the circuit device 112.

For example, FIG. 12 illustrates a display 1200 including a plot 1202 of example temperature distribution data and a plot 1204 of corresponding example gradient data, in accordance with various embodiments. In the display 1200, the temperature distribution data and the temperature gradient data are depicted along with reference lines indicating the temperature distribution and the temperature gradient values, respectively, expected if no gap is present in the imaged trace. The display 1200 indicates to an operator that there is a gap in the trace at approximately 3 centimeters from one end, and the magnitude of the discontinuity (e.g., measured by the magnitude of the temperature gradient at the gap) may indicate the size of the gap (e.g., the width of a crack or intervening material). In some embodiments, the plot 1204 of the gradient data may include an indicator (not shown) of a threshold determined to represent a gradient value above which a crack is likely. The value of this threshold may be determined empirically for different types of gaps.

As noted above, in some embodiments, the controller circuitry 104 and the processing circuitry 106 may be implemented by a single computing device configured with the functionality of the controller circuitry 104 and the processing circuitry 106. For example, a common processing device or processing devices may perform operations described herein as performed by the controller circuitry 104 and as performed by the processing circuitry 106. Other resources may be shared between the controller circuitry 104 and the processing circuitry 106, such as data storage devices and communication hardware.

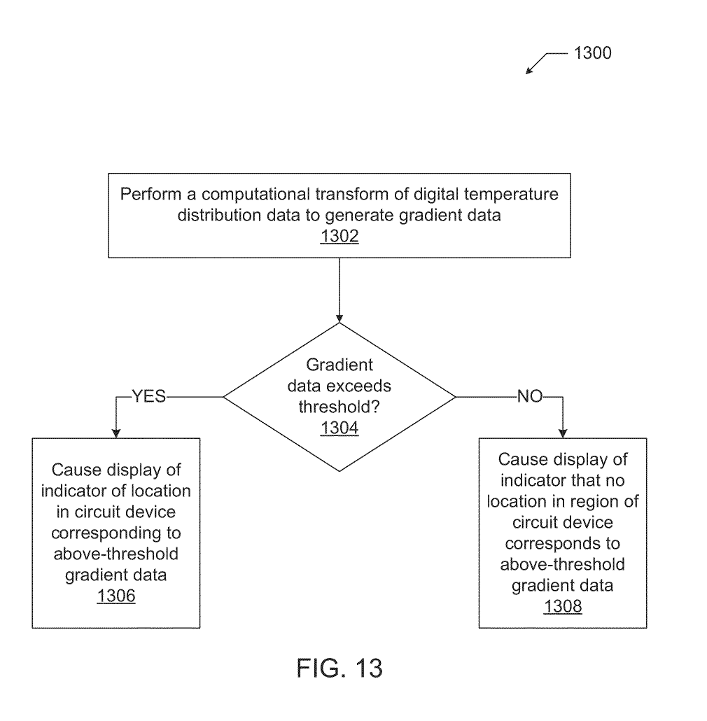

FIG. 13 is a flow diagram of an illustrative method 1300 for inspecting a circuit device, in accordance with various embodiments. The operations of the method 1300 (and the other methods described herein), although illustrated as performed in a particular sequence for the sake of illustration, may be performed in parallel as suitable or in any other order. For example, for different subsets of the temperature data, operations related to generating gradient data may be performed in parallel with operations related to comparing the gradient data to a threshold.

Operations of the method 1300 (and the other methods described herein) may be described as performed by components of the processing circuitry 106 of the circuit device inspection system 100, for illustrative purposes, but the operations of the method 1300 (and the other methods described herein) may be performed by any suitably configured circuitry (e.g., the controller circuitry 104). Any of the operations of the method 1300 (and the other methods described herein) may be performed in accordance with any of the embodiments of the circuit device inspection system 100 described herein.

The method 1300 may begin at 1302, at which the processing circuitry 106 (e.g., the transform circuitry 134) may perform a computational transform of digital temperature distribution data to generate gradient data. The digital temperature distribution data may be indicative of a temperature distribution in a region of the circuit device 112. In some embodiments, the computational transformation may include numerical differentiation so that the gradient data is indicative of a temperature gradient in the region of the circuit device 112. In some embodiments, other computational transforms may be performed at 1302, such as noise reduction filtering. In some embodiments, the processing circuitry 106 may receive the digital temperature distribution data prior to (or in parallel with) the operations of 1302. As discussed above, in some embodiments, the receive circuitry 132 may receive the digital temperature distribution data directly from the IR camera 108, or may generate the digital temperature distribution data based on one or more IR images from the IR camera 108.

At 1304, the processing circuitry 106 (e.g., the compare circuitry 136) may compare the gradient data to one or more thresholds to determine whether some of the gradient data exceeds the threshold. As noted above, in some embodiments, comparing the gradient data to a threshold may include generating a heat map of the gradient data. In some embodiments, comparing the gradient data to a threshold may include comparing the gradient data to a single predetermined threshold representative of a gradient value at which a discontinuity in a conductive pathway in the circuit device 112 is likely.

If the processing circuitry 106 determines at 1304 that at least some of the gradient data exceeds the threshold, the processing circuitry 106 (e.g., the output circuitry 138) may proceed to 1306 and cause the display, on a display device (e.g., the display 150) of an indication of a location in the region of the circuit device 112 that corresponds to the at least some of the gradient data that exceeds the threshold. In particular, the display may indicate a location with a high magnitude temperature gradient that is suggestive of a discontinuity in a conductive trace at that location. In some embodiments, the display may take the form of any of those depicted in FIGS. 8-12, or any combination of such displays.

If the processing circuitry 106 determines at 1304 that none of the gradient data exceeds the threshold, the processing circuitry 106 (e.g., the output circuitry 138) may proceed to 1308 and cause the display, on a display device (e.g., the display 150) of an indication that the location in the region of the circuit device 112 corresponds to gradient data that exceeds the threshold. In some embodiments, this may take the form of displaying one of the displays of FIGS. 8-12 without any region or location indicated as having a significant gradient. In some embodiments, the operations 1308 may include displaying a textual or graphical message indicating that no location with the above-threshold gradient was identified.

As noted above, various embodiments of the systems and techniques disclosed herein may offer advantages over conventional approaches to defect localization. Various embodiments provide a quick and high-resolution circuit mapping capability previously not achieved. For example, a resolution of approximately 10 microns or better may be achieved with commercially available hardware and a data collection time measured in the seconds. Failures localized by the techniques disclosed herein may enable the isolation of electrical faults, a deficiency of other imaging techniques. Moreover, the use of infrared imaging may enable much faster processing than more intensive imaging techniques, such as x-ray or scanning acoustic microscope imaging. The techniques disclosed herein may be easily integrated as an in-line process monitoring metrology, an improvement over the exclusive use of off-line fault isolation and failure analysis. The systems and techniques disclosed herein also enable the location of gaps in three dimensions. Once identified, overlaying an image of the gap on an optical image or design may improve an operator's ability to interpret the gap data and may improve the success rate of fault isolation. As used herein, an “optical image” may refer to an image of the circuit device topography. In some embodiments, an optical image may be generated by the IR camera 108 using emissivity data. Additionally, the IR camera and supporting hardware utilized in various embodiments of the circuit device inspection system 100 may be cost-effectively acquired.

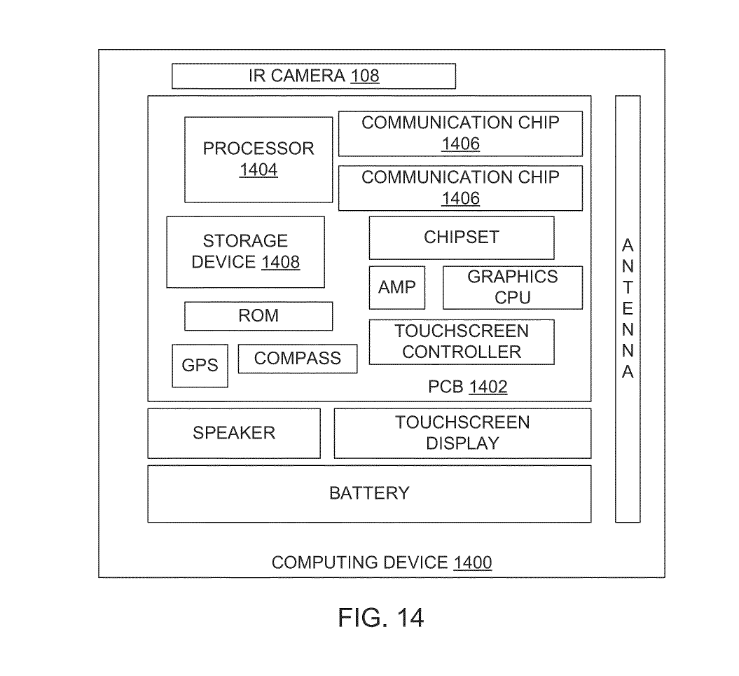

FIG. 14 is a block diagram of an example computing device 1400 that may provide some or all of the components of the circuit device inspection system 100, in accordance with various embodiments. For example, the computing device 1400 may provide the processing circuitry 106 and/or the controller circuitry 104. In some embodiments, the computing device 1400 may include the IR camera 108. In some embodiments, the computing device 1400 may include the pulse generator 114.

The computing device 1400 may house a board such as printed circuit board (PCB) 1402. The PCB 1402 may include a number of components, including (but not limited to) a processor 1404 and at least one communication chip 1406. The term “processor” or “processing device” may refer to any device or portion of a device that processes electronic data from registers and/or memory to transform that electronic data into other electronic data that may be stored in registers and/or memory. In some embodiments, the processor 1404 may be physically and electrically coupled to the at least one communication chip 1406. In some embodiments, the communication chip 1406 may be part of the processor 1404.

The computing device 1400 may include a storage device 1408. In some embodiments, the storage device 1408 may include one or more solid state drives. Examples of storage devices that may be included in the storage device 1408 include volatile memory (e.g., dynamic random access memory (DRAM)), non-volatile memory (e.g., read-only memory (ROM)), flash memory, and mass storage devices (such as hard disk drives, compact discs (CDs), digital versatile discs (DVDs), and so forth). The storage device 1408 may store any of the data discussed herein, such as the IR images generated by the IR camera 108, the digital temperature distribution data, the gradient data, graphical representations of various regions of the circuit device, and any other suitable data.

Depending on its applications, the computing device 1400 may include other components. These other components may include, but are not limited to, a graphics processor, wireless transceiver circuitry, a digital signal processor, a crypto processor, a chipset, an antenna, a display, a touchscreen display, a touchscreen controller, a battery, an audio codec, a video codec, a power amplifier, a global positioning system (GPS) device, a compass, a Geiger counter, an accelerometer, a gyroscope, a speaker, an image capture device, and control circuitry for voice and/or video communication.

The communication chip 1406 and the antenna may enable wireless communications for the transfer of data to and from the computing device 1400. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 1406 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible broadband wide area (BWA) networks are generally referred to as WiMAX networks, an acronym that stands for Worldwide Interoperability for Microwave Access, which is a certification mark for products that pass conformity and interoperability tests for the IEEE 802.16 standards. The communication chip 1406 may operate in accordance with a Global System for Mobile Communications (GSM), General Packet Radio Service (GPRS), Universal Mobile Telecommunications System (UMTS), High Speed Packet Access (HSPA), Evolved HSPA (E-HSPA), or LTE network. The communication chip 1406 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1406 may operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond. The communication chip 1406 may operate in accordance with other wireless protocols in other embodiments.

The computing device 1400 may include a plurality of communication chips 1406. For instance, a first communication chip 1406 may be dedicated to shorter range wireless communications such as Wi-Fi and Bluetooth, and a second communication chip 1406 may be dedicated to longer range wireless communications such as GPS, EDGE, GPRS, CDMA, WiMAX, LTE, EV-DO, and others. In some embodiments, the communication chip 1406 may support wired communications.

In various implementations, the computing device 1400 may implement any suitable functionalities typically implemented in a laptop, a netbook, a notebook, an ultrabook, a smartphone, a tablet, a personal digital assistant (PDA), an ultra mobile PC, a mobile phone, a desktop computer, a monitor, a set-top box, an entertainment control unit, a digital camera, a portable music player, or a digital video recorder. In some embodiments, the computing device 1400 may be any other electronic device that processes data.

The following paragraphs provide examples of the embodiments disclosed herein. Example 1 is one or more non-transitory computer readable media having instructions thereon that, in response to execution by one or more processing devices of a computing system, cause the computing system to: receive digital temperature distribution data indicative of a temperature distribution in a region of a circuit device, wherein a first location on the circuit device is held at a first temperature and a second location on the circuit device is held at a second temperature different from the first temperature; perform a computational transformation of the digital temperature distribution data to generate gradient data, wherein the computational transformation includes numerical differentiation and wherein the gradient data is indicative of a temperature gradient in the region of the circuit device; compare the gradient data to a threshold to determine that at least some of the gradient data exceeds the threshold; and output an indication of a location in the region of the circuit device that corresponds to the at least some of the gradient data that exceeds the threshold.

Example 2 may include the subject matter of Example 1, and may further specify that receive digital temperature distribution data indicative of a temperature distribution in a region of a circuit device comprises receive infrared image data of the region of the circuit device from an infrared camera and generate the temperature distribution data based on the infrared image data.

Example 3 may include the subject matter of any of Examples 1-2, and may further specify that the numerical differentiation comprises numerical differentiation of a portion of the digital temperature distribution data corresponding to a trace in the circuit device.

Example 4 may include the subject matter of any of Examples 1-3, and may further specify that compare the gradient data to a threshold comprises generate a gradient heat map of the gradient data.

Example 5 may include the subject matter of any of Examples 1-4, and may further specify that output an indication of a location in the region of the circuit device that corresponds to the at least some of the gradient data that exceeds the threshold comprises cause the display, on a display device, of an indicator of the at least some of the gradient data superimposed on a graphical representation of the region of the circuit device.

Example 6 may include the subject matter of Example 5, and may further specify that the graphical representation of the region of the circuit device is a circuit layout of the region of the circuit device.

Example 7 may include the subject matter of any of Examples 1-6, and may further specify that output of an indication of a location in the region of the circuit device that corresponds to the at least some of the gradient data that exceeds the threshold comprises cause the display, on a display device, of a graph comparing the gradient data to corresponding locations in the region of the circuit device.

Example 8 may include the subject matter of any of Examples 1-7, and may further specify that the region of the circuit device is parallel to and between two opposing surfaces of the circuit device.

Example 9 is a computing system for inspection of a circuit device, including: circuitry to receive digital temperature distribution data, wherein the digital temperature distribution data is indicative of a temperature distribution in a region of the circuit device; circuitry to perform a computational transformation of the digital temperature distribution data to generate gradient data, wherein the computational transformation includes numerical differentiation and wherein the gradient data is indicative of a temperature gradient in the region of the circuit device; and circuitry to cause the display of the gradient data and a visual indication of a correspondence between the gradient data and the region of the circuit device.

Example 10 may include the subject matter of Example 9, and may further include an infrared camera interface to couple to an infrared camera, wherein the digital temperature distribution data is based on infrared image data of the region of the circuit device generated by the infrared camera.

Example 11 may include the subject matter of Example 10, and may further specify that a first location on the circuit device is held at a first temperature and a second location on the circuit device is held at a second temperature different from the first temperature.

Example 12 may include the subject matter of any of Examples 10-11, and may further include a controller circuitry interface, wherein the controller circuitry interface is to couple to a controller circuitry, the controller circuitry is to couple to the infrared camera, and the controller circuitry is to cause the infrared camera to capture infrared images in response to control signals provided to the infrared camera by the controller circuitry.

Example 13 may include the subject matter of Example 12, and may further specify that the controller circuitry is to couple to a first temperature source and to a second temperature source, cause the first temperature source to generate a first temperature output in response to control signals provided to the first temperature source by the controller circuitry, and cause the second temperature source to generate a second temperature output in response to control signals provided to the second temperature source by the controller circuitry.

Example 14 may include the subject matter of Example 13, and may further specify that the first temperature output is a different temperature than the second temperature output.

Example 15 may include the subject matter of any of Examples 9-14, and may further specify that the circuitry to cause the display of the gradient data and a visual indication of a correspondence between the gradient data and the region of the circuit device comprises circuitry to cause the display of an indicator of the gradient data superimposed on a graphical representation of the region of the circuit device.

Example 16 may include the subject matter of Example 15, and may further specify that the graphical representation of the region of the circuit device is an image of the region of the circuit device.

Example 17 may include the subject matter of any of Examples 9-16, and may further specify that the circuitry to cause the display of the gradient data and a visual indication of a correspondence between the gradient data and the region of the circuit device comprises circuitry to cause the display of a graph comparing the gradient data to corresponding locations along a trace in the region of the circuit device.

Example 18 is a system for inspection of a circuit device, including: an infrared camera; a first temperature source; a second temperature source; a controller circuitry, coupled to the infrared camera, to the first temperature source, and to the second temperature source, wherein the controller circuitry is to provide control signals to the infrared camera to cause the infrared camera to capture an infrared image of a region of the circuit device, wherein the controller circuitry is to provide control signals to the first temperature source to cause the first temperature source to generate a first temperature output, wherein the controller circuitry is to provide control signals to the second temperature source to cause the second temperature source to generate a second temperature output, and wherein the first temperature output is coupled to a first location on the circuit device and the second temperature output is coupled to a second location on the circuit device; and processing circuitry, coupled to the infrared camera, to receive infrared image data generated by the infrared camera, to generate digital temperature distribution data based on the infrared image data, and to perform a computational transformation of the digital temperature distribution data to generate gradient data, wherein the computational transformation includes numerical differentiation and wherein the gradient data is indicative of a temperature gradient in the region of the circuit device.

Example 19 may include the subject matter of Example 18, and may further specify that the controller circuitry is included in a housing separate from a housing of the processing circuitry.

Example 20 may include the subject matter of Example 18, and may further specify that the processing circuitry and the controller circuitry include one or more common processing devices.

Example 21 is a method for inspecting a circuit device, including: performing a computational transformation of digital temperature distribution data to generate gradient data, wherein the digital temperature distribution data is indicative of a temperature distribution in a region of a circuit device, the computational transformation includes numerical differentiation, and the gradient data is indicative of a temperature gradient in the region of the circuit device; comparing the gradient data to a threshold to determine that at least some of the gradient data exceeds the threshold; and causing the display, on a display device, of an indication of a location in the region of the circuit device that corresponds to the at least some of the gradient data that exceeds the threshold.

Example 22 may include the subject matter of Example 21, and may further specify that performing the computational transformation comprises applying a noise reduction filter.

Example 23 may include the subject matter of any of Examples 21-22, and may further include, prior to performing a computational transformation of digital temperature distribution data, generating the digital temperature distribution data based on one or more infrared images of the region of the circuit device.

Example 24 may include the subject matter of Example 23, and may further specify that the region of the circuit device is located at a depth below a surface of the circuit device, and wherein the depth is determined based on the one or more infrared images of the region of the circuit device.

Example 25 may include the subject matter of any of Examples 21, and may further specify that the region of the circuit device comprises a substantially linear region of the circuit device corresponding to a conductive trace.

Example 26 is an apparatus including means for performing any of the methods of Examples 21-25.

Example 27 is one or more computer readable media having instructions thereon that, in response to execution by one or more processing devices of an apparatus, cause the apparatus to perform any of the methods of Examples 21-25.

What is claimed is:

1. One or more non-transitory computer readable media having instructions thereon that, in response to execution by one or more processing devices of a computing system, cause the computing system to:
receive digital temperature distribution data indicative of a temperature distribution in a region of a circuit device, wherein a first location on the circuit device is held at a first temperature and a second location on the circuit device is held at a second temperature different from the first temperature;
perform a computational transformation of the digital temperature distribution data to generate gradient data, wherein the computational transformation includes numerical differentiation and wherein the gradient data is indicative of a temperature gradient in the region of the circuit device;
compare the gradient data to a threshold to determine that at least some of the gradient data exceeds the threshold; and
output an indication of a location in the region of the circuit device that corresponds to the at least some of the gradient data that exceeds the threshold.

2. The one or more non-transitory computer readable media of claim 1, wherein receive digital temperature distribution data indicative of a temperature distribution in a region of a circuit device comprises receive infrared image data of the region of the circuit device from an infrared camera and generate the temperature distribution data based on the infrared image data.

3. The one or more non-transitory computer readable media of claim 1, wherein the numerical differentiation comprises numerical differentiation of a portion of the digital temperature distribution data corresponding to a trace in the circuit device.

4. The one or more non-transitory computer readable media of claim 1, wherein compare the gradient data to a threshold comprises generate a gradient heat map of the gradient data.

5. The one or more non-transitory computer readable media of claim 1, wherein output an indication of a location in the region of the circuit device that corresponds to the at least some of the gradient data that exceeds the threshold comprises cause the display, on a display device, of an indicator of the at least some of the gradient data superimposed on a graphical representation of the region of the circuit device.

6. The one or more non-transitory computer readable media of claim 5, wherein the graphical representation of the region of the circuit device is a circuit layout of the region of the circuit device.

7. The one or more non-transitory computer readable media of claim 1, wherein output of an indication of a location in the region of the circuit device that corresponds to the at least some of the gradient data that exceeds the threshold comprises cause the display, on a display device, of a graph comparing the gradient data to corresponding locations in the region of the circuit device.

8. The one or more non-transitory computer readable media of claim 1, wherein the region of the circuit device is parallel to and between two opposing surfaces of the circuit device.

9. A computing system for inspection of a circuit device, comprising:
circuitry to receive digital temperature distribution data, wherein the digital temperature distribution data is indicative of a temperature distribution in a region of the circuit device;
circuitry to perform a computational transformation of the digital temperature distribution data to generate gradient data, wherein the computational transformation includes numerical differentiation and wherein the gradient data is indicative of a temperature gradient in the region of the circuit device; and
circuitry to cause the display of the gradient data and a visual indication of a correspondence between the gradient data and the region of the circuit device.

10. The computing system of claim 9, further comprising an infrared camera interface to couple to an infrared camera, wherein the digital temperature distribution data is based on infrared image data of the region of the circuit device generated by the infrared camera.

11. The computing system of claim 10, wherein a first location on the circuit device is held at a first temperature and a second location on the circuit device is held at a second temperature different from the first temperature.

12. The computing system of claim 10, further comprising a controller circuitry interface, wherein the controller circuitry interface is to couple to a controller circuitry, the controller circuitry is to couple to the infrared camera, and the controller circuitry is to cause the infrared camera to capture infrared images in response to control signals provided to the infrared camera by the controller circuitry.

13. The computing system of claim 12, wherein the controller circuitry is to couple to a first temperature source and to a second temperature source, cause the first temperature source to generate a first temperature output in response to control signals provided to the first temperature source by the controller circuitry, and cause the second temperature source to generate a second temperature output in response to control signals provided to the second temperature source by the controller circuitry.

14. The computing system of claim 13, wherein the first temperature output is a different temperature than the second temperature output.

15. The computing system of claim 9, wherein the circuitry to cause the display of the gradient data and a visual indication of a correspondence between the gradient data and the region of the circuit device comprises circuitry to cause the display of an indicator of the gradient data superimposed on a graphical representation of the region of the circuit device.

16. The computing system of claim 15, wherein the graphical representation of the region of the circuit device is an image of the region of the circuit device.

17. The computing system of claim 9, wherein the circuitry to cause the display of the gradient data and a visual indication of a correspondence between the gradient data and the region of the circuit device comprises circuitry to cause the display of a graph comparing the gradient data to corresponding locations along a trace in the region of the circuit device.

18. A system for inspection of a circuit device, comprising:
an infrared camera;
a first temperature source;
a second temperature source;
a controller circuitry, coupled to the infrared camera, to the first temperature source, and to the second temperature source, wherein the controller circuitry is to provide control signals to the infrared camera to cause the infrared camera to capture an infrared image of a region of the circuit device, wherein the controller circuitry is to provide control signals to the first temperature source to cause the first temperature source to generate a first temperature output, wherein the controller circuitry is to provide control signals to the second temperature source to cause the second temperature source to generate a second temperature output, and wherein the first temperature output is coupled to a first location on the circuit device and the second temperature output is coupled to a second location on the circuit device; and
processing circuitry, coupled to the infrared camera, to receive infrared image data generated by the infrared camera, to generate digital temperature distribution data based on the infrared image data, and to perform a computational transformation of the digital temperature distribution data to generate gradient data, wherein the computational transformation includes numerical differentiation and wherein the gradient data is indicative of a temperature gradient in the region of the circuit device.

19. The system of claim 18, wherein the controller circuitry is included in a housing separate from a housing of the processing circuitry.

20. The system of claim 18, wherein the processing circuitry and the controller circuitry include one or more common processing devices.

21. A method for inspecting a circuit device, comprising:
performing a computational transformation of digital temperature distribution data to generate gradient data, wherein the digital temperature distribution data is indicative of a temperature distribution in a region of a circuit device, the computational transformation includes numerical differentiation, and the gradient data is indicative of a temperature gradient in the region of the circuit device;
comparing the gradient data to a threshold to determine that at least some of the gradient data exceeds the threshold; and
causing the display, on a display device, of an indication of a location in the region of the circuit device that corresponds to the at least some of the gradient data that exceeds the threshold.

22. The method of claim 21, wherein performing the computational transformation comprises applying a noise reduction filter.

23. The method of claim 21, further comprising, prior to performing a computational transformation of digital temperature distribution data, generating the digital temperature distribution data based on one or more infrared images of the region of the circuit device.

24. The method of claim 23, wherein the region of the circuit device is located at a depth below a surface of the circuit device, and wherein the depth is determined based on the one or more infrared images of the region of the circuit device.

25. The method of claim 21, wherein the region of the circuit device comprises a substantially linear region of the circuit device corresponding to a conductive trace.
